(19) United States
(12) Patent Application Publication
(10) Pub. No.: US 2014/0205355 A1
(43) Pub. Date: Jul. 24, 2014

(54) MEDIA SKEW REDUCTION

(71) Applicant: Hewlett-Packard Development Company, L.P., (US)

(72) Inventors: Kevin LO, Vancouver, WA (US); Wesley R. SCHALK, Camas, WA (US); Luke P. SOSNOWSKI, Camas, WA (US)

(73) Assignee: HEWLETT-PACKARD DEVELOPMENT COMPANY, L.P., Houston, TX (US)

(21) Appl. No.: 13/744,811

(22) Filed: Jan. 18, 2013

(51) Int. Cl. B41J 11/00

(52) U.S. Cl. CPC B41J 11/0095
USPC 400/579

(57) ABSTRACT

A system for reducing media skew within a printer, including a first roller, a second roller, a first sensor to measure the buckle height of a print media between the first and second rollers and generate a first signal, and a controller to receive the first signal and adjust the rotational speed of one of the first or second roller based on the first signal.

### BACKGROUND

Printers are widely used to print images on print media. Typically, unbalanced forces acting on the print media during printing operations cause the print media to become skewed relative to a print media travel path within the printer. Such skewing of print media often results in a misalignment of the resulting image which is printed on the surface thereof. Therefore, it is desirable to remove any skew which may have accumulated in print media prior to disposition of a printed image on the surface thereof.

### BRIEF DESCRIPTION OF THE DRAWINGS

For a detailed description of various examples of the invention, reference will now be made to the accompanying drawings in which:

FIG. 1 shows a partially schematic side view of a printer in accordance with the principles disclosed herein;

FIG. 2 shows an enlarged schematic side view of the de-skewing assembly housed with the printer of FIG. 1 in accordance with the principles disclosed herein;

FIG. 3 shows a schematic top view of a piece of print media disposed within the de-skewing assembly of FIG. 2 in accordance with the principles disclosed herein;

FIGS. 4 and 5 show sequential enlarged schematic side views of the de-skewing assembly of FIG. 2 engaged in a de-skewing process in accordance with the principles disclosed herein; and

FIG. 6 shows a method of reducing skew within a piece of print media in accordance with the principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct mechanical or electrical connection, through an indirect mechanical or electrical connection via other devices and connections, through an optical electrical connection, or through a wireless electrical connection. The phrases “printing operations” and “print operations” generally refer to any movement of print media within a printer, whether or not an image is actually being printed on the surface of the print media.

### DETAILED DESCRIPTION

The following discussion is directed to various examples of the invention. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example.

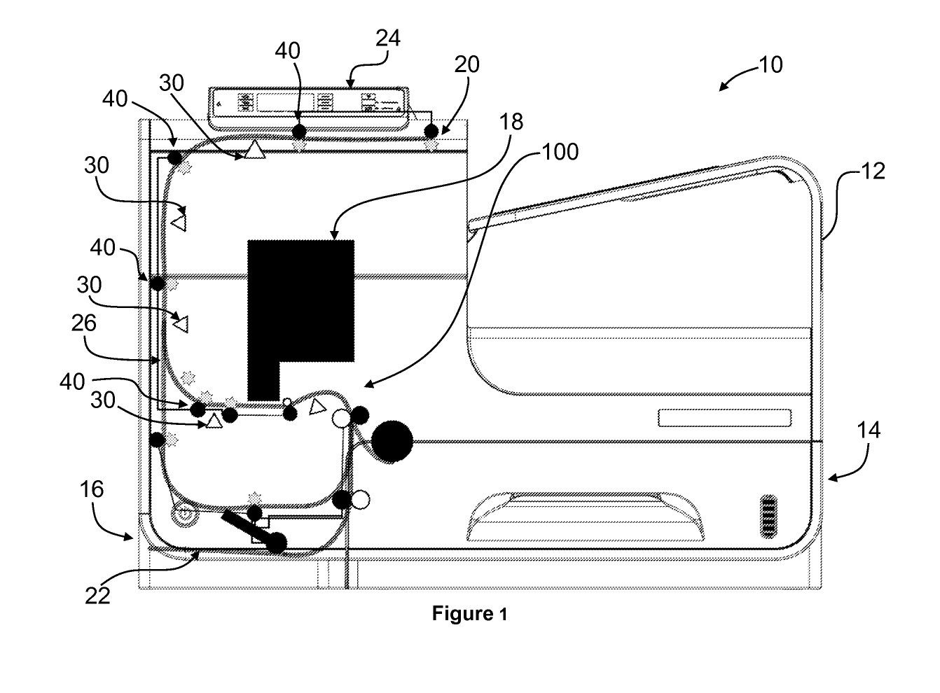

Referring now to FIG. 1, wherein a printer 10 for printing an image on a piece of print media 22 is shown. In general, printer 10 comprises a housing 12, a first print media storage tray 14, a second print media storage tray 16, a print mechanism 18 for dispensing or depositing an image onto the surface of the print media 22, an outlet 20 for print media 22 to exit the printer 10 once a print job is completed, and a control panel 24. Print mechanism 18 may be any suitable printing mechanism for depositing or printing an image on the surface of print media 22, while still complying with the principles disclosed herein. Printer 10 also comprises a print media travel path 26 which is arranged to guide print media 22 through the printer 10, and a de-skewing assembly 100 disposed along the path 26. A number of roller pinches 40 are disposed along the print media travel path 26 to drive or advance print media 22 along the path 26 during printing operations. Further, a plurality of sensors 30 are disposed at various locations along path 26 and, as will be explained in more detail below, are arranged to sense the location and/or presence of print media 22 as it is advanced along the path 26, such as for example, during printing operations. In the current example, sensors 30 are optical sensors; however, any suitable sensor for detecting the presence of print media 22 along the print media travel path 26 may be used while still complying with the principles disclosed herein.

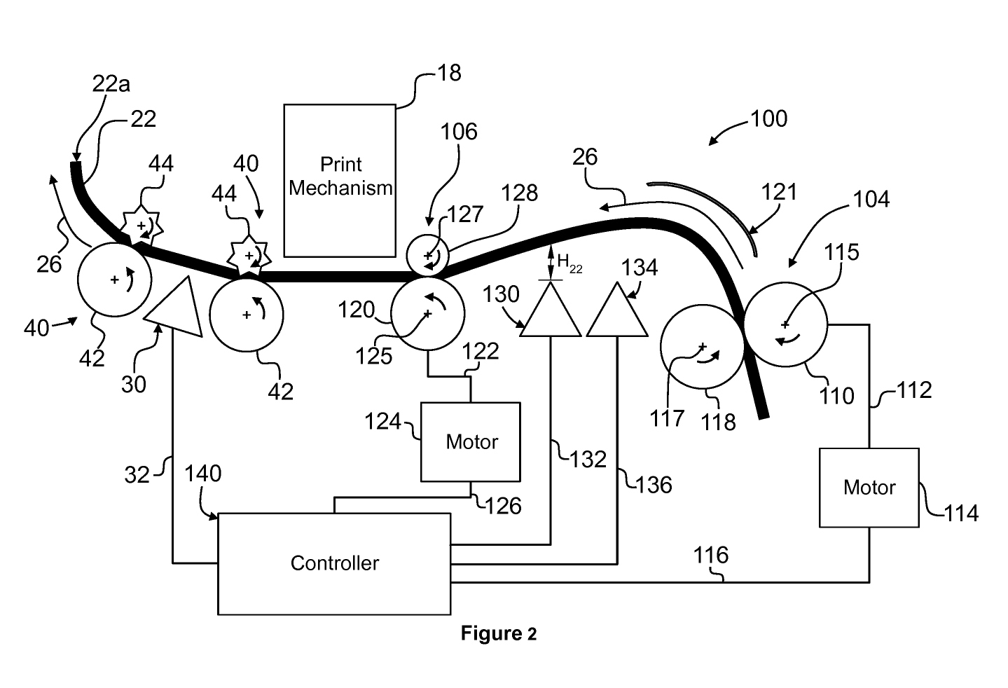

Referring now to FIG. 2, in this example the de-skewing assembly 100 generally comprises a first or turn pinch 104, a second or feed pinch 106, a first or turn motor 114, a second or feed motor 124, an optical sensor 134, a buckle height sensor 130, and a controller 140. Each of these components will now be described in more detail below.

Turn pinch 104 further comprises a turn roller 110 and a first pinch roller 118. Turn roller 110 is disposed along the path 26 and is arranged to rotate about an axis 115. The first pinch roller is also disposed along the path 26, immediately opposite the turn roller 110, and is arranged to rotate about an axis 117 which is substantially parallel to and radially offset from the axis 115. As will be described in more detail below, the turn roller 110 and the first pinch roller 118 engage one another such that a piece of print media 22 is wedged or pinched between the rollers 110, 118. Therefore, the roller 118 is driven to rotate by the roller 110, via the contact or engagement between the rollers 110, 118. Thus, by rotating the roller 110 print media 22 is driven or advanced along the path 26 between the rollers 110, 118. The turn motor 114 is mechanically coupled to the roller 110 and is arranged to drive or force the roller 110 to rotate about the axis 115. Motor 114 is also electrically coupled to the controller 140 via a conductor 116. In some examples, motor 114 is a servo motor; however, any suitable motor or driving means may be used.

Feed pinch 106 is disposed along the path 26, adjacent to the turn pinch 104 and further comprises a feed roller 120 and a second pinch roller 128. Feed roller 120 is disposed along the path 26 and is arranged to rotate about an axis 125. A second pinch roller 128 is disposed along the path 26, immediately opposite the feed roller 120, and arranged to rotate about an axis 127 which is substantially parallel to and radially offset from the axis 125. As will be described in more detail below, the feed roller 120 and the second pinch roller 128 engage one another such that a piece of print media 22 is wedged or pinched between the rollers 120, 128. Therefore, the roller 128 is driven to rotate by the roller 120, via the contact or engagement between the rollers 120, 128. Thus, by rotating the roller 120, print media 22 is driven or advanced along the path 26, between the rollers 120, 128. The second motor 124 is mechanically coupled to the roller 120 and is arranged to drive or force the roller 120 to rotate about the axis 125. Motor 124 is also electrically coupled to the controller 140 via a conductor 126. In some examples, motor 124 is a servo motor; however, any suitable motor or driving means may be used.

A curved surface 121 is disposed adjacent the print media travel path 26, between the rollers 110, 118, and the rollers 120, 128. As will be described in more detail below, during print operations surface 121 directs or forces the leading edge 22a of the print media 22 to bend or deform in order to guide or direct print media 22 toward the rollers 120, 128 after passing between the rollers 110, 118.

Optical Sensor 134 is disposed along the print media travel path 26 between the turn pinch 104 and the feed pinch 106, and is electrically coupled to the controller 140 via a conductor 136. In this example, sensor 134 is an optical sensor and is arranged to measure or detect the presence of the leading edge 22a of print media 22, between the turn pinch 104 and the feed pinch 106. Sensor 134 is further arranged to generate a signal, which is routed to the controller 140 via conductor 136. In this example, buckle height sensor 130 is also disposed along the print media travel path 26 between the turn pinch 104 and the feed pinch 106, and is electrically coupled to the controller 140 via conductor 132. Sensor 130 is arranged to measure the buckle height H₂₂ of the print media 22 or the distance between the sensor 130 and the print media 22, and to generate a signal which is routed to controller 140 via conductor 132. As will be described in more detail below, the height H₂₂ corresponds to the amount of deflection or buckle of the print media 22 which occurs during de-skewing operations.

As previously described, controller 140 is electrically coupled to the turn motor 114, the feed motor 124, the sensor 130, and the sensor 134, via conductors 116, 126, 132, and 136, respectively. In some examples, the controller 140 is also electrically coupled to other sensors and/or motors (e.g., sensors 30) disposed throughout the printer (e.g., printer 10). As will be described in more detail below, controller 140 is generally arranged to adjust or control the output speed of the motors 114 and 124. In some examples, the controller 140 alters or adjusts the speed of the motors 114 and 124 based on the output signal of the sensors 130, 134, and/or the sensors 30 (e.g., sensors 30) disposed within the printer (e.g., printer 10).

As previously described, roller pinches 40 are disposed along the print media travel path 26, downstream of the print mechanism 18 and the system 100 (note: only two roller pinches 40 are shown in FIG. 2). Each of the pinches 40 generally comprise a driver roller 42 and a driven star roller 44, which has a plurality of teeth. During printing operations, the print media 22 is drawn into the roller pinches 40 such that it is engaged by the teeth of each star roller 44 and the surface of each driver roller 42, thereby allowing the media 22 to be advanced along the path 26. One sensor 30 is shown disposed between the roller pinches 40, along the path 26. This sensor 30 is electrically coupled to the controller 140 via a conductor 32. As will be described in more detail below, sensor 30 is arranged to sense the presence of print media 22 as it advances along the path 26.

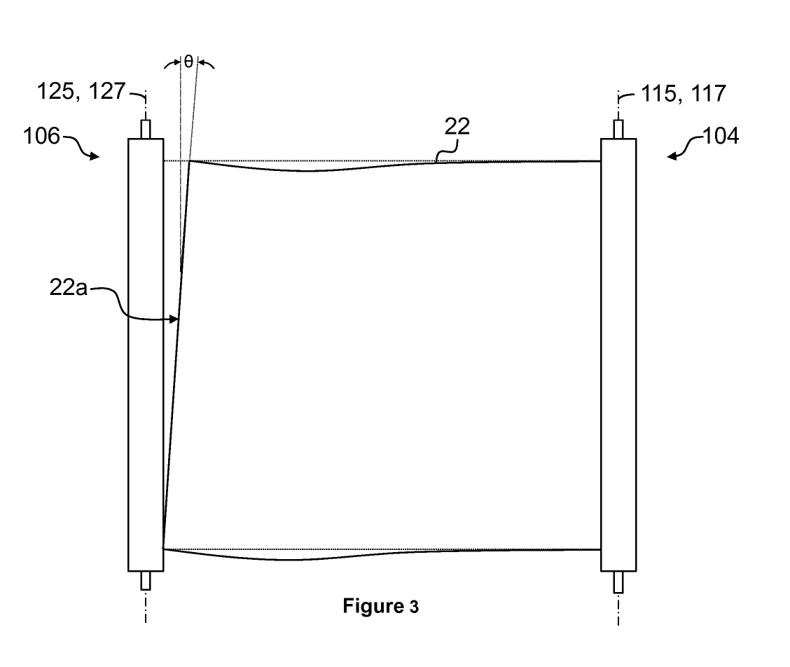

Referring briefly to FIG. 3, during printing operations, print media 22 which is traveling along the print media travel path 26 (note: path 26 is not specifically shown in FIG. 3) may develop skew. Skew generally refers to deflection or disorientation of the media 22 with in the printer 10 and is typically caused by unbalanced forces acting on the media 22 during printing operations. In particular and as shown in FIG. 3, a piece of print media 22 having a leading edge 22a, is being advanced by the turn pinch 104 toward the feed pinch 106. Also as shown in FIG. 3, the leading edge 22a of the media 22 is disposed at an angle 8 relative to the axes 115, 117, 125, 127 and is thus skewed. Such skew often results in the misalignment of the printed image on the surface of the print media 22. Thus, removal of media skew before the media 22 reaches the print mechanism (e.g., print mechanism 18) is desirable. Accordingly, examples disclosed herein present methods for removing or preventing media skew in the print media 22 through use of de-skewing assembly 100.

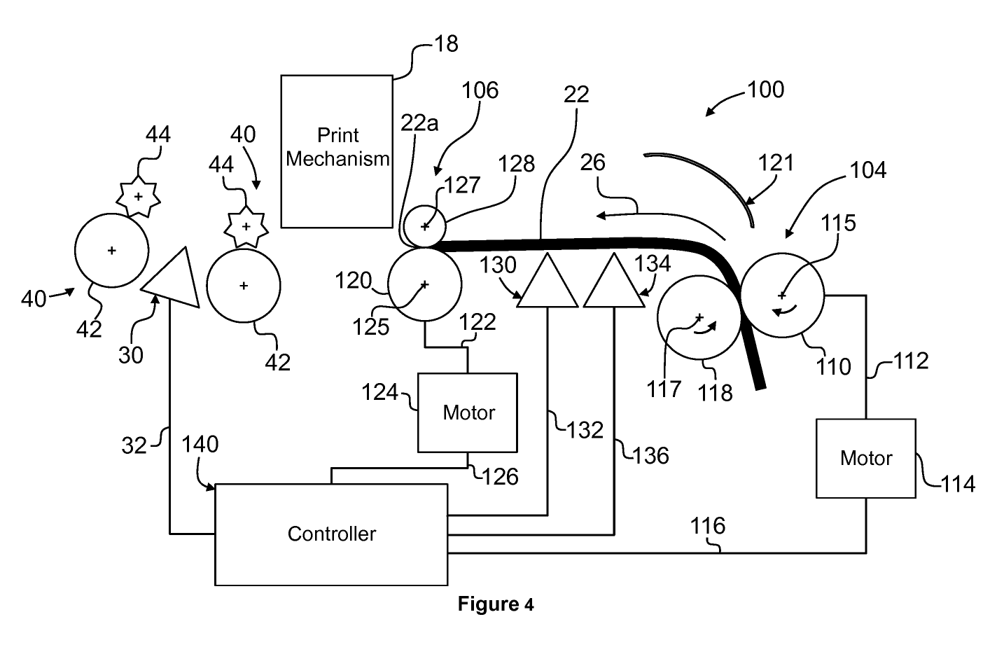

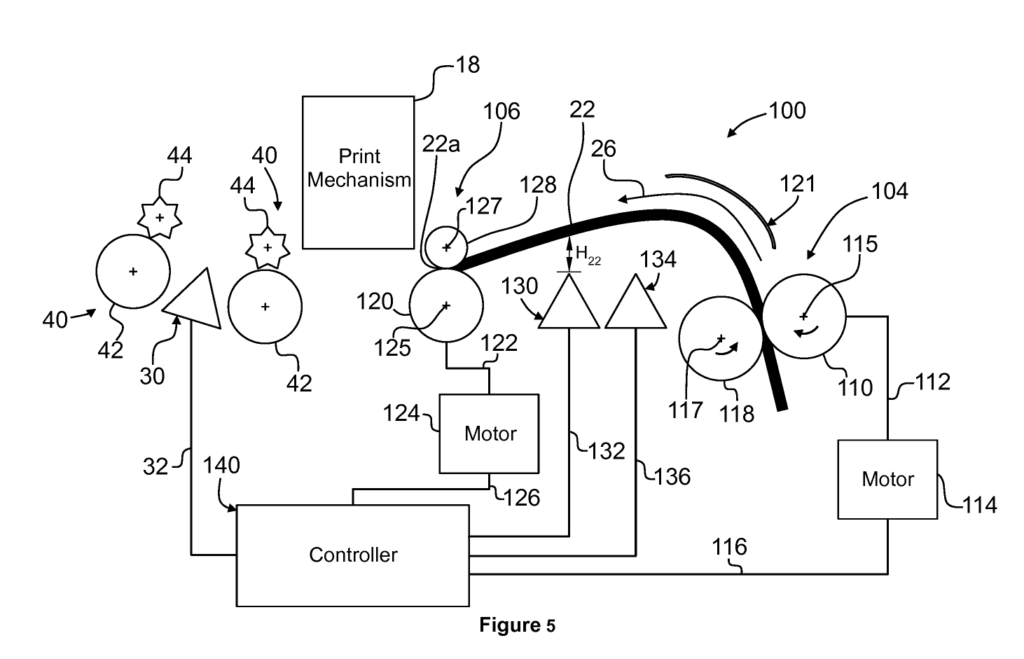

Referring now to FIGS. 4 and 5, wherein a process for removing skew via the system 100 is sequentially shown. Initially, print media 22 is advanced along the path 26 via the turn pinch 104, toward the feed pinch 106. The rollers 120 and 128 of the pinch 106 are initially fixed and are therefore not rotating about the axes 125, 127 respectively. Thus, when the leading edge 22a of the print media 22 contacts the rollers 120, 128, its advancement along the path 26 is halted. Next, the turn roller 110 continues to rotate in order to substantially reduce or eliminate any skew in the media 22. Thereafter, the feed roller 120 and the second pinch roller 128 are driven to rotate about their respective axes 125, 127 in order to advance the now de-skewed print media 22 toward the print mechanism 18. Each of these steps and procedures will now be explained in more detail below.

Referring now to FIG. 4, initially print media 22 is advanced from a storage location such as, for example, the print media storage trays 14 and 16 shown in FIG. 1, via the turn pinch 104. Specifically, the motor 114 drives or forces the roller 110 to rotate about the axis 115 which in turn causes the roller 118 to rotate about the axis 117 in the opposite direction as the roller 110. Print media 22 is engaged or pinched between the surfaces of the rollers 110 and 118 such that it is advanced along path 26 when the rollers 110, 118 are rotating in the manner described above. After advancing past the rollers 110, 118, the leading edge 22a of the media 22 contacts the curved surface 121 such that it is then directed toward the feed pinch 106.

Additionally, sensor 134 detects the leading edge 22a of the print media 22 as it advances toward the feed pinch 106 and generates a signal which is routed to the controller 140 via conductor 136. In some examples, upon receiving the signal routed from the sensor 134, the controller 140 directs the turn roller 110 to continue to rotate for a predetermined number of revolutions in order to cause the leading edge 22a of the print media 22 to be driven into engagement with the feed pinch 106. At this point, the rollers 120, 128 within the feed pinch 106 are not rotating, and thus, when the leading edge 22a of the print media 22 contacts the rollers 120, 128, advancement of the leading edge 22a along the path 26 is halted.

Referring now to FIG. 5, once the leading edge 22a of the print media 22 contacts the rollers 120, 128, continued rotation of the turn roller 110 effectively drives the leading edge 22a of the print media 22 into engagement with the now stopped rollers 120, 128. This action causes the leading edge 22a of the print media 22 to substantially align with the axis 125 of the feed roller 120 and axis 127 of the second pinch roller 128, and therefore substantially reduces or eliminates any skew which may have accumulated in the print media 22 (i.e., the angle 8 as shown in FIG. 3 is substantially reduced or eliminated).

Further, once contact is initiated between the media 22 and the feed pinch 106, the additional revolutions of the roller 110 cause the print media 22 to bulge or buckle along the print media travel path 26 between the pinches 104 and 106. If the buckle of the print media 22 is too large the surface of the media will contact the surfaces lining the print media path 26 (e.g., the curved surface 121), resulting in drag or friction in the print media 22 which further leads to the production of additional skew within the print media 22. This drag or friction can also, in some examples, lead to an alteration in the velocity or feed rate of the print media 22 along the path 26. Further, in some cases, the print media 22 may even become damaged as a result of contacting the surfaces lining the print media path 26. Thus, in some examples, the sensor 130 measures the buckle height H₂₂ as the turn roller 110 drives the leading edge 22a of the print media 22 into engagement with the feed pinch 106 and generates a signal which is routed to the controller 140 via the conductor 132. The controller 140 then compares the measured height H₂₂ to a range of predetermined values. If the measured height is outside of the predetermined range, the controller 140 directs the roller 120 to rotate, via the motor 124, such that the print media 22 is advanced along the path 26 toward the print mechanism 18. The predetermined values for the height H₂₂ may be based on a variety of factors, such as, for example, the overall width or height of the print media travel path 26, the type of print media 22, the desired angle of approach for the media 22 into the feed pinch 106, and the desired shape or position on the media 22 within the print zone (i.e., proximate to the print mechanism 18). Additionally, in some examples, the value of H₂₂ may vary along the length of a piece of print media 22. In particular, in some examples, the desired value of H₂₂ may be smaller for the trailing edge of the print media 22 relative to the desired value of H₂₂ for the leading edge (e.g., edge 22a).

Referring again to FIGS. 1 and 2, after the de-skewing process described above is completed, the print media 22 is advanced through continued rotation of the feed roller 120 and the turn roller 110. In order to prevent further dragging of the print media 22 along one of the sides of the path 26, the relative speeds and/or angular positions of the motors 114, 124 and thus the relative speeds and/or angular positions of the rollers 110, 120 may be continuously adjusted via the controller 140 based on a variety of inputs, such as, for example, the buckle height H₂₂ measured by the sensor 130, a predetermined timing sequence, the output of the sensors 30 disposed along the print media travel path 26, and/or the type of print media 22 being routed along the path 26. Each of these considerations will be described in more detail below.

First, as previously described, in some examples the controller 140 adjusts or controls the relative rotational speeds and/or angular positions of the rollers 110 and 120 independently of one another based on the output of the sensor 130. More specifically and in a manner which is similar to that which is described above during the initial de-skewing process, the sensor 130 may monitor the buckle height H₂₂ of the print media disposed between the turn pinch 104 and the feed pinch 106 as the rollers of each pinch 104, 106 are rotating to advance the print media 22 along path 26. If the measured value for the height H₂₂ falls outside of the acceptable range of values, previously described, the controller 140 may adjust the speeds of the roller 110 and/or the roller 120 in order to maintain a desired buckle height H₂₂ within the predetermined range. The acceptable range for the value of the buckle height H₂₂ may vary depending on factors such as, for example, the amount of slip occurring in the pinches 104, 106, the desired angle of entry for the media 22 in to the pinch 106, drag on the media 22 along the path 26 between the pinches 104, 106, and variations in the diameters of the rollers 110, 120 (e.g., due to manufacturing tolerances).

Further and as previously described, in some examples, the controller 140 adjusts or controls the relative rotational speeds and/or angular positions of the rollers 110 and 120 based on a predetermined timing sequence. In these examples, the controller 140 automatically adjusts the relative rotational speeds and/or angular positions of one or both of the rollers 110 and 120 based on a predetermined time sequence which accounts for certain known parameters such as, for example, the diameters of the rollers 110, 120, variations in feed rates for different sections or regions along the print media travel path 26, and known variations in the relative feeds rates of the turn pinch 104 and the feed pinch 106.

Still further and as previously described, in some examples, the controller 140 adjusts or controls the relative rotational speeds and/or angular positions of the rollers 110 and 120 based on the output of the sensors 30 disposed along the travel path 26. Specifically, sensors 30 are electrically coupled to the controller 140 by any suitable means and are arranged to sense the location of print media 22 at various locations along path 26 and generate signals which are routed to the controller 140. For example, FIG. 2 shows one such sensor 30 coupled to the controller 140 via a conductor 32. During operation, the sensor 30 senses the presence of print media 22 along the path 26 proximate the sensor 30 and generates a signal which is routed to the controller 140 via the conductor 32. While only one sensor 30 is shown in FIG. 2, it should be appreciated that each of the sensors 30 shown in FIG. 1 are coupled to the controller 140 in a similar way. Thus, a description of the sensor 30 shown in FIG. 2 may also be applied to fully describe the arrangement and function of each of the other sensors 30 shown in FIG. 1, which are positioned at various other points along the path 26.

The signals produced by the sensors 30 are then used to determine whether, for example, certain regions or sections along the print media travel path 26 are experiencing varying feed rates. In particular, the controller 140 receives and analyzes the signals from the sensors 30 (e.g., through the conductor 32 for the sensor 30 shown in FIG. 2) and adjusts the relative speeds of the rollers 110, 120 via the motors 114, 124, respectively, based on the received signals. In some examples, signals produced by the sensors 30 allow the controller 140 to determine if the media 22 has arrived at a particular location along the path 26 at the expected time. If the arrival of the media 22 at this point along the path 26 is sufficiently delayed, the controller 140 may infer (e.g., through software) that a jam of print media 22 may have occurred somewhere along the path 26, and thus will direct the rollers 110, and 120 to stop rotating. Additionally, in other examples, the output of a particular sensor 30, located along the path 26 allows the controller 140 to determine that the print media 22 is about to experience an elevated amount of drag (e.g., due to a known turn in the path 26 at that location), thereby prompting the controller 140 to adjust the speed ratio of the rollers 110 and 120 in order to adequately compensate for the expected increase in drag. Further, in some examples, the output of a particular sensor 30 or sensors 30 may indicate to the controller 140 that print media 22 is about to depart a certain region or section of the print media travel path 26, thereby allowing the controller 140 to anticipate a reduction in the drag or friction experienced by the media 22 and thus the roller pinches 104, 106 and motors 114, 124. The controller 140 may then adjust the relative rotational speeds and/or angular positions of the rollers 110, 120 in order to adequately compensate for this anticipated drop in drag or fiction. Thus, by detecting the progress of print media 22 throughout the print media travel path 26 via the sensors 30, the controller 140 may adjust the speeds of the rollers 110 and 120 in order to prevent dragging of the print media 22 along the surfaces lining the print media travel path 26 and therefore prevent further skew from accumulating in the print media 22. It should further be appreciated that in some examples, the controller 140 may adjust the relative rotational speeds and angular positions of the rollers 110, 120 based on the combined output of the sensors 30 and the sensor 134, while still complying with the principles disclosed herein.

Still further and also as previously described, in some examples, the controller 140 adjusts or controls the relative rotational speeds and/or angular positions of the rollers 110, 120 in the manner described above based on the type of print media 22 being fed along the print media travel path 26. In particular, different types of print media 22 may have a wide range of thickness and stiffness properties. Thus, by noting the type of print media 22 being used, the controller 140 may adjust the relative speeds of the motor 114 and/or the motor 124 in order to ensure that skew is adequately reduced or removed for the given type of print media 22. For example, if a relatively thick type of print media 22, such as cardstock, is being routed along the print media travel path, the controller 140 may reduce the speed of the turn roller 110 via the motor 114 in order to avoid excess buckling between the pinches 104, and 106. In some examples, the type of print media is manually selected by a user or operator of the printer 10 via some sort of interface, such as, for example, the control panel 24, while in other examples, the type of print media 22 is automatically determined. For example, in some implementations, the type of print media 22 is automatically determined by the controller 140 through interpretation of the signals routed from a driver (e.g., from a computer or similar device), through caliper measurements, and/or through interpretation of light reflection or scatter off of the print media 22 itself.

While examples disclosed here have described and shown the controller 140 to be coupled to the motors 114, 124 via conductors 116 and 126, respectively, and coupled to sensors 130 and 134 via conductors 132 and 136 respectively, in other examples, no such conductors may be included and the controller 140 may be electrically coupled to various components via a wireless or optical connection, while still complying with the principles disclosed herein. Additionally, while examples disclosed herein have described and shown the de-skewing assembly 100 disposed within the printer 10, other examples may utilize the de-skewing assembly 100 described herein within other types of devices, such as, for example, a roll media printer, or a media-feeding scanner.

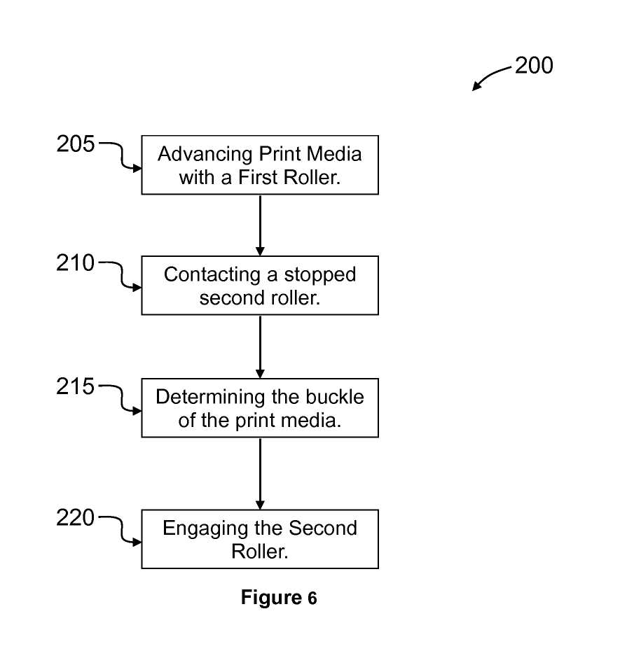

Referring now to FIG. 6, wherein a method 200 for reducing skew within piece of print media (e.g., print media 22) is shown. Though depicted sequentially as a matter of convenience, at least some of the operations shown can be performed in a different order and/or performed in parallel. Further, some embodiments may perform only some of the operations shown.

Initially, method 200 begins by advancing a piece of print media with a first roller. In particular, print media is advanced via engagement or contact with a first roller (e.g., turn roller 110) at block 205. Thereafter, the print media contacts a second roller (e.g., feed roller 120) at block 210 that is fixed or is stopped, thus halting any further advance of the print media beyond the second roller. After the print media has made contact and is halted by the stationary second roller in block 210, a determination is made as to the amount of buckle which the print media experiences between the first and second rollers (e.g., such as through measurement of the buckle height H₂₂ through sensor 130). Finally, the method 200 includes a step of engaging the second roller to rotate in block 220 and thus advancing the print media based on the determined amount of buckle in block 215.

The above discussion is meant to be illustrative of the principles and various examples of the present invention. Numerous variations and modifications will become apparent to those skilled in the art once the above disclosure is fully appreciated. It is intended that the following claims be interpreted to embrace all such variations and modifications.

What is claimed is:

1. A system for reducing media skew within a printer, comprising:
a first roller;
a second roller;
a first sensor to measure the buckle height of a print media between the first and second rollers and generate a first signal; and
a controller to receive the first signal and adjust the rotational speed of one of the first or second roller based on the first signal.

2. The system of claim 1, further comprising:
a first motor to drive the first roller; and
a second motor to drive the second roller;
wherein the first and second motors are coupled to the controller.

3. The system of claim 2, wherein the controller is arranged to adjust the rotational speed of both the first and second rollers based on the first signal.

4. The system of claim 2, wherein the controller is arranged to adjust the rotational speed of one of the first or second roller based on the type of print media.

5. The system of claim 2, wherein the controller is arranged to adjust the rotational speed of one of the first or second roller based on a predetermined time sequence.

6. The system of claim 2, further comprising:
a second sensor to measure the position of the print media along a print media travel path and generate a second signal;
wherein the controller is arranged to receive the second signal and adjust the rotational speed of one of the first or second roller based on the second signal.

7. A printer, comprising:
a first pair of rollers disposed along a media travel path;
a second pair of rollers disposed along the media travel path;
a first motor coupled to one of the first pair of rollers and having a first rotational speed and a first angular position;
a second motor coupled to one of the second pair of rollers and having a second rotational speed and a second angular position;
a plurality of first sensors disposed along the media travel path, downstream of the second pair of rollers, wherein each of the plurality of first sensors is arranged to detect the presence of a print media and generate a first signal; and
a controller coupled to the first motor, the second motor, and the plurality of first sensors to receive the first signals and to adjust at least one of the rotational speeds and at least one of the angular positions based on the first signals to reduce skew within the print media.

8. The printer of claim 7, further comprising:
a second sensor disposed between the first and second pairs of rollers to measure the buckle height of the print media and generate a second signal;
wherein the second sensor is coupled to the controller and wherein the controller is arranged to adjust at least one of the rotational speeds and to adjust at least one of the angular positions based on the second signal.

9. The printer of claim 7, wherein the controller is arranged to adjust the rotational speeds and the angular positions based on the first signals to reduce skew within the print media.

10. The printer of claim 7, wherein the controller is arranged to adjust at least one of the rotational speeds and at least one of the angular positions based on a thickness of the print media.

11. The printer of claim 7, wherein the controller is arranged to adjust at least one of the rotational speeds and at least one of the angular positions based on a predetermined time sequence.

12. The printer of claim 7, further comprising:
a third sensor to measure the position of the leading edge of the print media along the media travel path, between the first and second pairs of rollers and generate a third signal;
wherein the controller is arranged to adjust at least one of the rotational speeds and at least one of the angular positions based on the third signal.

13. A method of reducing skew within a printer, comprising:
advancing a print media with a first roller;
contacting a stopped second roller with a leading edge of the print media;
urging the print media forward with the first roller after contacting the stopped second roller to reduce skew in the print media;
determining a buckle of the print media after contacting the stopped second roller with the leading edge of the print media; and
engaging the second roller to advance the print media.

14. The method of claim 13, wherein determining the buckle of the print media comprises measuring the buckle height of the print media with a sensor disposed between the first roller and the second roller.

15. The method of claim 13, further comprising sensing the position of the print media along a print media travel path.

16. The method of claim 15, wherein sensing the position of the print media along a print media travel path comprises sensing the position of the print media along a print media travel path with at least one of sensor disposed along the print media travel path.

17. The method of claim 13, further comprising varying at least one of a rotational speed of the first roller and a rotational speed of the second roller after engaging the second roller to advance the print media.

18. The method of 17, wherein varying at least one of the rotational speeds of the first roller and the second roller comprises varying the rotational speeds of both the first roller and the second roller.

19. The method of 17, wherein varying at least one of the rotational speeds of the first roller and the second roller comprises varying at least one of the rotational speeds of the first roller and the second roller based on the buckle of the print media between the first roller and the second roller.
